(19) United States
(12) Patent Application Publication
(10) Pub. No.: US 2025/0322247 A1
(43) Pub. Date: Oct. 16, 2025

(54) METHODS AND APPARATUS FOR STOCHASTIC MANIFOLD LEARNING FOR CLASS IMBALANCE MITIGATION

(71) Applicants: Anthony Rhodes, Portland, OR (US); Sangita Ravi Sharma, Portland, OR (US); Lama Nachman, San Francisco, CA (US)

(72) Inventors: Anthony Rhodes, Portland, OR (US); Sangita Ravi Sharma, Portland, OR (US); Lama Nachman, San Francisco, CA (US)

(21) Appl. No.: 19/251,354

(22) Filed: Jun. 26, 2025

(51) Int. Cl. G06N 3/09

(52) U.S. Cl. CPC G06N 3/09

(57) ABSTRACT

An example apparatus includes interface circuitry, machine-readable instructions, and at least one processor circuit to be programmed by the machine-readable instructions to evaluate an anchor data point for an augmentation dataset, the augmentation dataset included in a training dataset of a machine learning model, populate the augmentation dataset based on a linear interpolation between the anchor data point and an anchor twin data point, and perform a classification task using the machine learning model based on the augmentation dataset.

### BACKGROUND

In binary classification settings, a class imbalance exists when one class is represented by a majority of instances present in a data set, while another class is represented only in a minority of instances. Class imbalances can be further magnified in multi-class, multi-label, and/or multi-instance learning associated with deep learning models. Deep learning models exhibiting class imbalance result in biased models that decrease output accuracy.

### BRIEF DESCRIPTION OF THE DRAWINGS

FIG. 1 illustrates an example stochastic manifold learning (SML) workflow performed using example predictive model executor circuitry in accordance with methods and apparatus disclosed herein.

FIG. 2 illustrates generation of synthetic data points, anchor points, and anchor-twin points as part of stochastic manifold learning performed using the example predictive model executor circuitry of FIG. 1.

FIG. 3 illustrates example results associated with deepfake classification using stochastic manifold learning disclosed herein and a baseline FakeCatcher (FC) algorithm.

FIG. 4 is a block diagram of an example known implementation of the predictive model executor circuitry of FIG. 1.

FIG. 5 is a flowchart representative of example machine-readable instructions and/or example operations that may be executed, instantiated, and/or performed by example programmable circuitry to implement the example predictive model executor circuitry of FIG. 1.

FIG. 6 is a flowchart representative of example machine-readable instructions and/or example operations that may be executed, instantiated, and/or performed by example programmable circuitry to implement the example predictive model executor circuitry of FIG. 1 to perform stochastic manifold learning (SML) to generate an augmentation dataset.

FIG. 7 is a block diagram of an example processing platform including programmable circuitry structured to execute, instantiate, and/or perform the example machine readable instructions and/or perform the example operations of FIGS. 5-6 to implement the example predictive model executor circuitry of FIG. 1.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 5-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Supervised learning includes the use of labeled training data, with each data sample belonging to a known class or category. Class imbalance in binary classification represents the presence of significantly fewer samples of one class relative to another class. Learning from imbalanced datasets presents a challenge when working with large datasets, given that majority class data (e.g., associated with healthy patients in a medical diagnosis task) can be prevalent as compared to minority class data (e.g., associated with patients exhibiting a rare disease). As such, training data with a class imbalance can result in over-classification of the majority group due to an increase in the prior probability of majority class data, whereas instances associated with the minority class data can be misclassified more often as compared to the majority class data. Neural networks trained on imbalanced data are not able to accurately predict a positive class of interest, with evaluation metrics (e.g., accuracy) generated from neural networks trained on the imbalanced data potentially misleading a data analyst (e.g., high scores incorrectly indicating good performance). As such, data class imbalance represents a significant challenge for data modeling applications, particularly in cases where data extraction is expensive and/or minority class data outcomes are rare or elusive (e.g., medical diagnostics for rare diseases). Given that predictive models rely on training data that approximates the diversity of “in the wild” data, data scarcity and underrepresentation can significantly impair model generalizability.

Known approaches to address class imbalance with traditional machine learning techniques include (1) alleviating a bias towards the majority class data by altering training data to decrease the imbalance and/or (2) modifying the model's underlying learning or decision process to increase the model's sensitivity towards the minority class data. Such approaches can include data-level techniques for mitigating class imbalance, as well as algorithm-level techniques or a combination of both. Data-level techniques include over-sampling and under-sampling, resulting in the modification of training distributions to decrease the level of imbalance and/or reduce noise (e.g., anomalies, mislabeled samples, etc.). While under-sampling can be used to discard random samples from the majority class data, over-sampling can be used to duplicate random samples in the minority class data. One such over-sampling approach is a Synthetic Minority Over-sampling Technique (SMOTE), which produces artificial minority samples by interpolating between existing minority samples and their nearest minority neighbors. Variants to SMOTE (e.g., Borderline-SMOTE, Safe-Level-SMOTE, etc.) improve the SMOTE algorithm by also considering majority class data neighbors (e.g., limiting over-sampling to samples located near class borders, defining regions to prevent over-sampling in overlapping regions, etc.). Other approaches include Adaptive Synthetic Sampling Approach for Imbalanced Learning (ADASYN), which generates synthetic samples for minority class data, where the number of samples generated is proportional to a difficulty of learning. Separately, algorithm-level methods developed for addressing class imbalance do not change the training data distribution, instead focusing on shifting a decision threshold in a way that reduces bias towards the majority class data while increasing the importance of the minority class data. Data-level and algorithm-level methods can also be combined, performing data sampling to reduce class noise and/or imbalance before applying cost-sensitive learning to achieve bias reduction associated with majority class data. However, existing methods for addressing data class imbalances associated with deep learning-based neural networks can be improved to achieve better accuracy.

Methods and apparatus disclosed herein introduce a novel data augmentation technique (e.g., stochastic manifold learning (SML)) for class imbalance mitigation. As such, methods and apparatus disclosed herein mitigate the negative impact of class imbalance on predictive modeling. In examples disclosed herein, manifold learning is optimized for classification tasks by generating an augmentation dataset (e.g., per epoch) consisting of linear interpolations of minority class data points. In examples disclosed herein, synthetic interpolations are generated by first identifying anchor data points in the minority class data with low confidence and/or predictive accuracy. Leveraging the model latent space, methods and apparatus disclosed herein identify a neighborhood of similar datapoints with respect to the identified anchor data points. An acceptance sampling can be performed by sampling a datum from this neighborhood with an acceptance probability in proportion to a predictive model confidence for a given neighbor data point. If the neighbor data point is accepted, methods and apparatus disclosed herein generate a synthetic data point (e.g., consisting of a linear interpolation between the anchor datum and its neighbor), adding this new data point to a training dataset.

Methods and apparatus disclosed herein generate regions that correspond with incorrect and/or low confidence minority class data predictions in the classifier latent space to merge with high confidence regions. In examples disclosed herein, recalibration of the augmentation generation process for each epoch allows the data augmentation step to dynamically conform to the evolving model latent space during training. Methods and apparatus disclosed herein further demonstrate the effectiveness of SML on real-world, imbalanced data. For example, SNL data augmentation can be applied for identification of manipulated videos created using deep learning techniques (e.g., deepfake detection). For example, machine learning models trained on large datasets of real and synthetic videos and/or images to identify patterns and/or anomalies that indicate manipulation can perform with low accuracy in the presence of class imbalance (e.g., due to a greater number of training samples with authentic media as compared to training samples with manipulated media). SNL data augmentation can be used to train machine learning models to identify deepfakes with higher accuracies (e.g., distinguishing deepfakes from authentic media).

In examples disclosed herein, minority class data is oversampled during each training epoch using a local interpolation scheme. For example, methods and apparatus disclosed herein (1) perform acceptance sampling from the minority data classes based on classifier predictive error, (2) determine k neighbors of this datum using k-Nearest Neighbors (k-NN) in the latent space of the model (e.g., using sampling acceptance), (3) sample from this neighborhood using acceptance sampling, and (4) generate a synthetic interpolation between the anchor datum and neighbor data point, adding this new data point to the augmentation set for training. In examples disclosed herein, SML is generalizable to any predictive model training algorithm containing imbalanced data (e.g., model-and learning algorithm-agnostic). For example, SML can improve overall classifier performance, while mitigating the deleterious effects of class imbalance (e.g., false-positive risk (FPR), false-negative risk (FNR), etc.). As such, SML can significantly reduce real-world data acquisition costs, and has the potential to be used as part of a standard modeling and/or augmentation software-based toolkit.

Compared to known synthetic data augmentation sampling methods (e.g., Generative Adversarial Networks (GAN) and Variational Autoencoders (VAE)-based oversampling), methods and apparatus disclosed herein use an interpolation approach that frees data augmentation from computationally expensive training and/or inference steps required by an auxiliary mode (e.g., instead of requiring training and/or inference of a separate, compute-intensive generative model for data augmentation). Additionally, GAN and/or VAE-based generative data augmentation can be conventionally decoupled from a classifier training learning algorithm, such that methods typically perform data augmentation for a fixed classifier. Conversely, methods and apparatus disclosed herein directly fold data augmentation into the model learning algorithm itself. The SML algorithm disclosed herein can be implemented for a single model with end-to-end training, whereas VAE and similar data augmentation sampling methods require both sequential and coordinated training of auxiliary models (e.g., including a classifier). For example, SNL can be implemented as part of any learning algorithm paradigm, requiring no additional models, fine-tuning and/or cross-model calibrations.

In examples disclosed herein, SML can also be used to determine neighborhoods for data similarity assessment in the classifier latent space, performing augmentation dynamically (e.g., per epoch) to better align with model training. Furthermore, methods and apparatus disclosed herein employ acceptance sampling informed by model predictions to determine anchor points and/or relevant neighbors for generating synthetic data points, such that the number of synthetic samples per anchor is also determined dynamically, based on model predictive errors. In contrast, SMOTE-based techniques (e.g., Borderline-SMOTE) identify two classes of data augmentation reference points (e.g., noise and borderline). Specifically, noise points represent minority class data points with a neighborhood consisting solely of majority class data, where these noise points are effectively treated as outliers and ignored by known data augmentation-based processes. In examples disclosed herein, SML ameliorates such misaligned embedding instances by leveraging a dynamic training-data augmentation coupled process that uses error-based acceptance sampling. Similarly, borderline points are points with mixed neighborhoods consisting of minority class data and majority class data. While SML also identifies these important data points during the data augmentation process, a richer sampling logic is implemented as compared to known techniques, such that the data augmentation mechanism is informed by model predictive confidence.

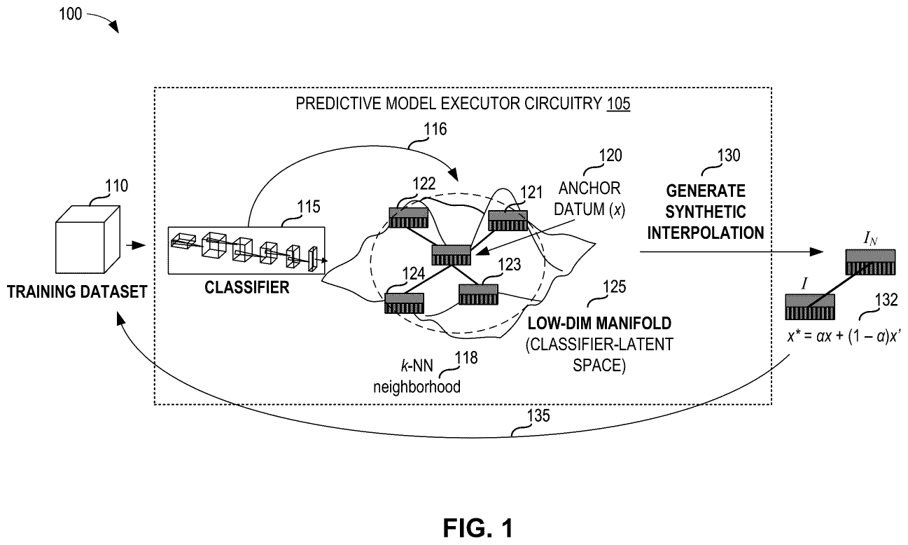

FIG. 1 illustrates an example stochastic manifold learning (SML) workflow 100 performed using example predictive model executor circuitry 105 in accordance with methods and apparatus disclosed herein. Overall, the SML workflow 100 results in the determination of neighborhoods for data similarity assessment in the classifier latent space, with augmentation performed dynamically to better align with model training. The SML workflow 100 also includes acceptance sampling informed by model predictions to determine anchor points and relevant neighbors for generating synthetic data points, with the number of synthetic samples per anchor also determined dynamically, based on model predictive errors. Given that SML is both a model-agnostic and data-agnostic algorithm, the SML workflow 100 can be folded into any learning algorithm paradigm, and requires no preternatural auxiliary modeling, fine-tuning steps or additional optimization. A model trained with SML can employ traditional stopping criteria (e.g., minimum hold-out prediction error, maximum number of epochs, etc.) or introduce class-specific stopping criteria (e.g., best equal-error-rate, minimum false-positive risk (FPR), etc.).

In the example of FIG. 1, the predictive model executor circuitry 105 initiates the SML workflow 100 by receiving a training dataset (e.g., training dataset 110). For example, the training dataset 110 represents a dynamic training dataset

$${D}^{( t )} = {D}_{train} ⋃ {D}_{aug}^{( t )} ,$$

where Dₜᵣₐᵢₙ indicates a fixed training set and

$${D}_{aug}^{( t )}$$

represents a per-epoch, dynamic augmentation dataset (e.g., where per-epoch refers to the number of times the entire training dataset 110 is passed through a given model during training). The training dataset 110 is provided to a classifier 115 to perform classification of the input data (e.g., classifier M_{θ}_{ₜ}, where θₜ represents model parameters at training epoch t). The predictive model executor circuitry 105 initiates a for-loop with an empty data augmentation dataset

$$( e . g . , {D}_{aug}^{( 0 )} , = ∅ ) ,$$

and generates synthetic data that are added to the empty augmentation dataset over time (e.g., by executing a for-loop over Dₜᵣₐᵢₙ). For example, the predictive model executor circuitry 105 samples minority class training datum (x) from the training dataset 110, where x˜Dₜᵣₐᵢₙ. The predictive model executor circuitry 105 passes the datum x through the classifier 115, yielding a predictive error (PE) (e.g., ΔPE(x)=|y−M_{θ}_{ₜ}(x)|, where y denotes the ground-truth label for x). Subsequently, the predictive model executor circuitry 105 determines, based on a set threshold, whether the datum x is accepted as an anchor for data augmentation (e.g., whether to generate synthetic data using x in subsequent steps). For example, the set threshold can be represented as ΔPE(x)>r, where r˜U[0,1], indicating that the datum x is accepted, and the predictive model executor circuitry 105 proceeds to determine a number of synthetic datapoints to generate with respect to the datum x. Conversely, the predictive model executor circuitry 105 rejects x when x does not meet the set threshold (e.g., ΔPE≤r). For example, datapoints can be accepted in proportion to their corresponding predictive error (PE).

Once the datum x is accepted, the predictive model executor circuitry 105 can determine the number of synthetic datapoints to generate based on the datum x, where the number of data augmentations (DA) to generate for the anchor datum x can be represented as DA(x)=round(ΔPE(x)·γ), such that γ∈Z⁺ represents a parameter that determines the scale of the number of data augmentations generated per anchor point. Based on the identified anchor point x (e.g., anchor point identification 116), the predictive model executor circuitry 105 proceeds to generate a k-Nearest Neighbors (k-NN) neighborhood (e.g., k-NN neighborhood 118) for the anchor datum x (e.g., anchor datum 120) in a classifier latent space (e.g., based on a selected distance metric) over all minority class training data (e.g., represented as N_{enc}(M_{θ}_{ₜ}(x)), where M_{θ}_{ₜ} represents the classifier 115 and enc indicates that the neighborhood is defined with respect to latent model embeddings). In examples disclosed herein, latent model embeddings can correspond to penultimate layer representations of a deep neural network (e.g., activations or feature vectors extracted from a layer immediately preceding the final output layer). For example, the k-NN neighborhood can include data points (e.g., data points 121, 122, 123, 124) that potentially share similar characteristics and/or features with the anchor point x in the latent space.

In the example of FIG. 1, the classifier latent space is represented as a low-dimensional manifold 125 (e.g., a representation of a high-dimensional dataset by a lower-dimensional structure which captures essential patterns and relationships within the data). The predictive model executor circuitry 105 proceeds to (1) sample a candidate anchor-twin (x′) from the k-NN neighborhood of x, where the anchor-twin can be represented as x′˜N_{enc}(M_{θ}_{ₜ}(x)), and (2) accept x′ as an anchor-twin with a probability of e^{-ΔPE(x′)·τ}, where ΔPE(x)=|y−M_{θ}_{ₜ}(x′)| and τ∈R⁺ represents a parameter that influences the acceptance probability threshold. The augmentation datum can be generated as a linear interpolation between the anchor point (x) and the anchor-twin (x′) (e.g., synthetic interpolation 130 between datapoint I and a neighboring datapoint I_{N}), such that the augmentation datum (x*) (e.g., augmentation datum 132) can be represented as x*=αx+(1−α)x′, where the interpolation weight is sampled as α˜U[0,1]. The predictive model executor circuitry 105 proceeds to add x* to the augmentation dataset, such that

$${D}_{aug}^{( t )} = {D}_{aug}^{( t )} ⋃ \{ {x}^{*} \}$$

and repeats the process of identifying additional augmentation datapoints (e.g., repeat datapoint identification 135) based on the number of originally determined data augmentations (DA) to generate for the anchor datum x.

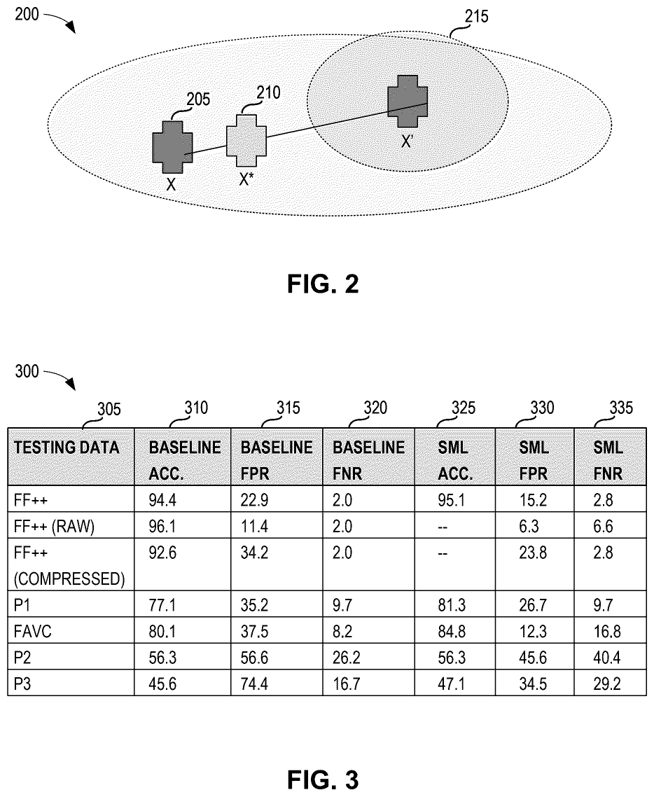

FIG. 2 illustrates example generation 200 of synthetic data point(s) (x*) 210, anchor point(s) (x) 205, and anchor-twin point(s) (x′) 215 as part of the stochastic manifold learning workflow 100 performed using the example predictive model executor circuitry 105 of FIG. 1. As described in connection with FIG. 1, SML dynamically (e.g., at each epoch) oversamples from the minority class(es) by generating an augmentation dataset to help mitigate class imbalance during training. At each epoch, the predictive model executor circuitry 105 generates an augmentation dataset so that the latent space manifold incrementally pushes minority class data rendering low predictive accuracy toward minority class data with better average predictive accuracy. For example, the stochastic elements of SML (e.g., anchor and anchor-twin sampling, data augmentation size, choice of interpolation weight, etc.) inject a dynamism into the model training regimen that fosters improvements in training data efficiency, such that each augmentation dataset is incrementally different and adapts in unison with the evolving latent space manifold of the classifier (e.g., classifier 115 of FIG. 1). In the example of FIG. 2, the anchor point (x) 205 exhibits a relatively large predictive error, while the anchor-twin (x′) 215 has a comparatively small predictive error. As described in connection with FIG. 1, the predictive model executor circuitry 105 applies SML to generate a synthetic data point (x*) 210 as a linear interpolation of x and x*. Through the application of SML, the anchor point 205 with large predictive error is subsumed into the manifold corresponding with the anchor-twin 215, yielding a reduction in minority class performance error.

FIG. 3 illustrates example result(s) 300 associated with deepfake classification using the SML workflow 100 disclosed herein and a baseline FakeCatcher (FC) algorithm. The baseline disclosed herein uses several conventional forms of data augmentation that are particular to deepfake detection and image processing pipelines. For example, the data augmentation baseline includes (1) augmentations to video resolution, (2) sampling rate, (3) traditional oversampling of the minority class, and (4) use of additional deepfake detection generators. Datasets used to generate result(s) 300 include over 100,000 frames of deepfake detection-related video content, with SML consistently improving and/or maintaining overall model performance while improving minority class performance. For example, FIG. 3 illustrates validation of the effectiveness of SML using several experiments on the challenging, real-world problem of binary deepfake classification using the FC algorithm. SML is tested versus a baseline FC training on a diverse set of seven datasets (e.g., testing data 305), including training on a FaceForensics++ (FF++) dataset (e.g., including FF++, FF++ (raw), FF++ (compressed)) which contains strong class imbalance properties (e.g., a 5:1 fake-to-real proportion). The datasets also include a Fake AV Celeb (FAVC) dataset and a set of three different proprietary deepfake datasets (e.g., P1, P2, and P3). In FIG. 3, the result(s) 300 include baseline accuracy 310, baseline false-positive risk (FPR) 315, baseline false-negative risk (FNR) 320, SML accuracy 325, SML FPR 330, and SML FNR 335. For example, by improving the overall model test performance (e.g., accuracy) as well as reducing the FPR (e.g., minority class performance metric) so that the risk better aligns with the FNR (e.g., majority class performance metric), methods and apparatus disclosed herein yield more stable model performance irrespective of the datum class. For example, in each case (e.g., encompassing over 10,000 train/test video segments), SML achieves performance gains in these targeted outcomes. As such, SNL acts as a data augmentation algorithm to help mitigate the negative impact of class imbalance on predictive modeling. For example, SNL optimizes manifold learning in a dynamic, generalizable way through informed, stochastic sampling that yields an augmentation dataset consisting of linear interpolations of minority class data points.

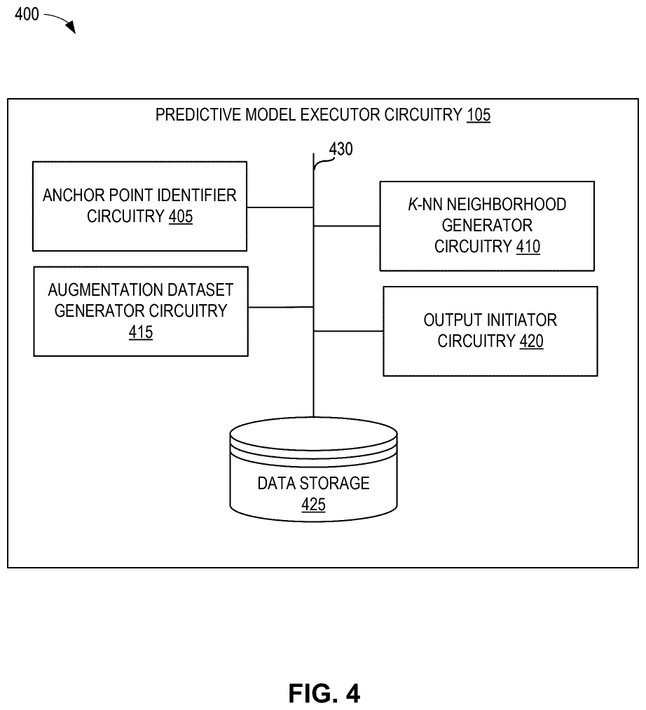

FIG. 4 is a block diagram 400 of an example known implementation of the predictive model executor circuitry 105 of FIG. 1 constructed in accordance with teachings of this disclosure for stochastic manifold learning for class imbalance mitigation. The predictive model executor circuitry 105 of FIG. 1 may be instantiated (e.g., creating an instance of, bring into being for any length of time, materialize, implement, etc.) by programmable circuitry. For example, programmable circuitry may be implemented by a Central Processing Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the predictive model executor circuitry 105 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In the example of FIG. 4, the predictive model executor circuitry 105 of FIG. 1 includes example anchor point identifier circuitry 405, example k-NN neighborhood generator circuitry 410, example augmentation dataset generator circuitry 415, example output initiator circuitry 420, and example data storage 425. The anchor point identifier circuitry 405, the k-NN neighborhood generator circuitry 410, the augmentation dataset generator circuitry 415, the output initiator circuitry 420, and the data storage 425 are in communication via an example bus 430.

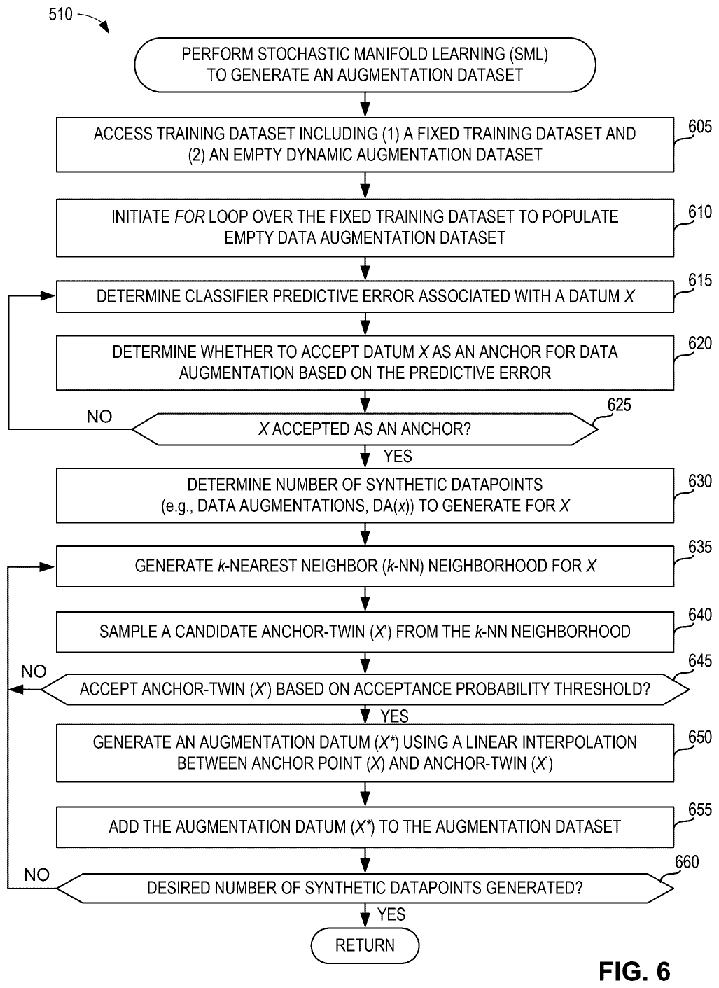

The anchor point identifier circuitry 405 identifies anchor point(s) by selecting data points from the minority class based on predictive error. For example, the anchor point identifier circuitry 405 samples a minority class data point x from a training dataset Dₜᵣₐᵢₙ (e.g., as part of the training dataset 110 of FIG. 1). The anchor point identifier circuitry 405 proceeds to pass x through the classifier (M_{↓}_{ₜ}) (e.g., classifier 115 of FIG. 1), yielding a predictive error (e.g., defined as ΔPE(x)=|y−M_{θ}_{ₜ}(x)|, where y denotes the ground-truth label for x). As such, the anchor point identifier circuitry 405 identifies data points in the minority class for potential augmentation to mitigate the occurrence of class imbalance when using machine learning models. As described in connection with FIG. 1, the anchor point identifier circuitry 405 accepts data points with high predictive errors as anchors for augmentation (e.g., anchor datum 120 of FIG. 1). For example, when the predictive error meets a set threshold (e.g., ΔPE(x)>r, where r ˜U[0,1]), then x is accepted as an anchor point. Otherwise, if x is rejected as an anchor point (e.g., does not meet the set threshold), the anchor point identifier circuitry 405 proceeds to sample another data point. For example, data points with higher predictive errors are more likely to be accepted as anchors, focusing augmentation efforts on areas where the model underperforms, as described in more detail in connection with FIG. 6.

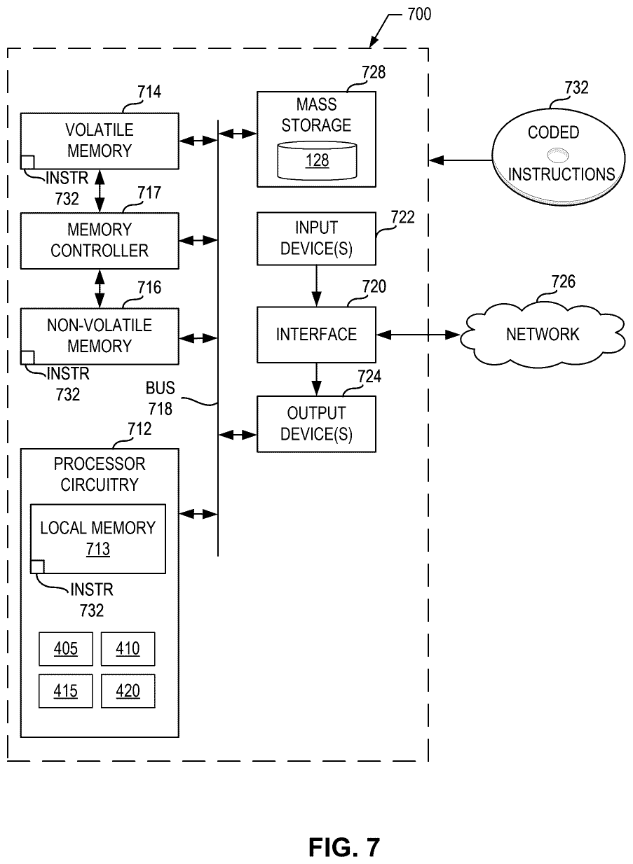

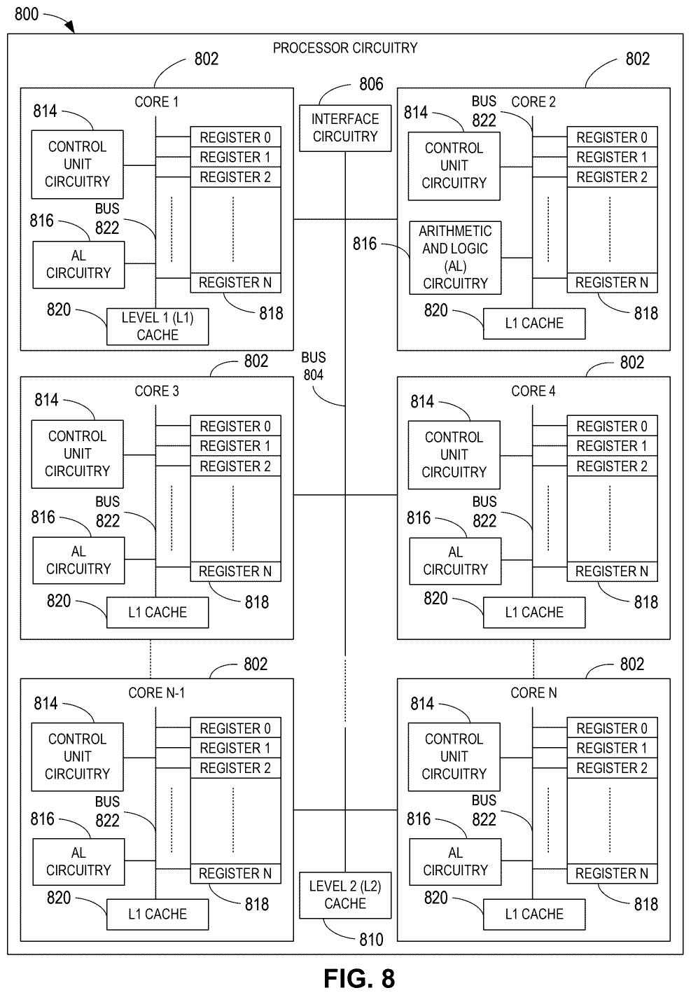

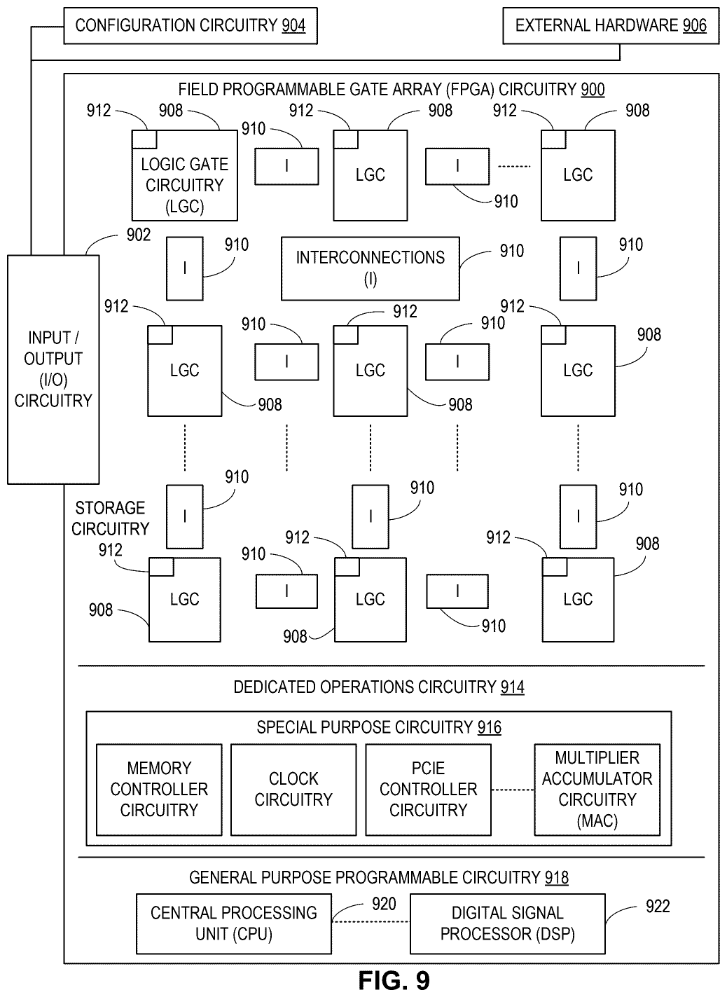

In some examples, the apparatus includes means for evaluating an anchor data point. For example, the means for evaluating an anchor data point may be implemented by anchor point identifier circuitry 405. In some examples, the anchor point identifier circuitry 405 may be instantiated by programmable circuitry such as the example programmable circuitry 712 of FIG. 7. For instance, the anchor point identifier circuitry 405 may be instantiated by the example microprocessor 800 of FIG. 8 executing machine executable instructions such as those implemented by at least block 620 of FIG. 6. In some examples, the anchor point identifier circuitry 405 may be instantiated by hardware logic circuitry, which may be implemented by an ASIC, XPU, or the FPGA circuitry 900 of FIG. 9 structured to perform operations corresponding to the machine readable instructions. Additionally or alternatively, the anchor point identifier circuitry 405 may be instantiated by any other combination of hardware, software, and/or firmware. For example, the anchor point identifier circuitry 405 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The k-NN neighborhood generator circuitry 410 identifies a k-Nearest Neighbors (k-NN) neighborhood in a latent space of the machine learning model to identify neighbors of the anchor point identified using the anchor point identifier circuitry 405. The k-NN algorithm can be used for classification tasks by finding the k closest data points (neighbors) to a given input (e.g., without making assumptions about the underlying data distribution). While examples disclosed herein use the k-NN algorithm, any other algorithm can be selected for generation of a neighborhood of data points surrounding the anchor point x. As shown in connection with FIG. 1, the k-NN neighborhood generator circuitry 410 generates the k-NN neighborhood 118 for x in the classifier 115 latent space (e.g., where the k-NN neighborhood is represented as N_{enc}(M_{θ}_{ₜ}(x))). The resulting k-NN neighborhood includes data points (e.g., data points 121, 122, 123, 124 of FIG. 1) that are similar to the anchor point x in the latent space, potentially sharing similar characteristics and/or features.

In some examples, the apparatus includes means for generating to generate a k-Nearest Neighbors (k-NN) neighborhood. For example, the means for generating to generate a k-NN neighborhood may be implemented by k-NN neighborhood generator circuitry 410. In some examples, the k-NN neighborhood generator circuitry 410 may be instantiated by programmable circuitry such as the example programmable circuitry 712 of FIG. 7. For instance, the k-NN neighborhood generator circuitry 410 may be instantiated by the example microprocessor 800 of FIG. 8 executing machine executable instructions such as those implemented by at least block 635 of FIG. 6. In some examples, the k-NN neighborhood generator circuitry 410 may be instantiated by hardware logic circuitry, which may be implemented by an ASIC, XPU, or the FPGA circuitry 900 of FIG. 9 structured to perform operations corresponding to the machine readable instructions. Additionally or alternatively, the k-NN neighborhood generator circuitry 410 may be instantiated by any other combination of hardware, software, and/or firmware. For example, the k-NN neighborhood generator circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The augmentation dataset generator circuitry 415 generates synthetic points through linear interpolation between the anchor point x and the anchor point's accepted neighbors. For example, the augmentation dataset generator circuitry 415 samples a candidate anchor-twin (x′) from the k-NN neighborhood, accepting an anchor-twin (x′) that meets a defined acceptance probability threshold (e.g., e^{-ΔPE(x′)·τ}). When the anchor-twin is accepted, the augmentation dataset generator circuitry 415 generates a synthetic data point (x*) (e.g., x*=αx+(1−α)x′). In examples disclosed herein, the number of synthetic points generated is proportional to the predictive error, controlled by parameters γ and τ. For example, the augmentation dataset generator circuitry 415 determines the number of synthetic data points (x*) to generate for anchor x based on a number of data augmentations to perform (e.g., DA(x)=round(ΔPE(x)·γ)). As such, the process of generating the k-NN neighborhood (e.g., k-NN neighborhood 118 of FIG. 1), sampling a candidate anchor-twin (x′) from the neighborhood, and generating a synthetic data point is repeated a given number of times based on the determined number of data augmentations to perform to dynamically adjust the augmentation based on the predictive error associated with the anchor point (ΔPE(x)) and the ground-truth label for the anchor point (γ). As such, the augmentation dataset generator circuitry 415 generates more synthetic data for anchor points with higher predictive errors.

In some examples, the apparatus includes means for populating the augmentation dataset. For example, the means for populating the augmentation dataset may be implemented by augmentation dataset generator circuitry 415. In some examples, the augmentation dataset generator circuitry 415 may be instantiated by programmable circuitry such as the example programmable circuitry 712 of FIG. 7. For instance, the augmentation dataset generator circuitry 415 may be instantiated by the example microprocessor 800 of FIG. 8 executing machine executable instructions such as those implemented by at least block 650 of FIG. 6. In some examples, the augmentation dataset generator circuitry 415 may be instantiated by hardware logic circuitry, which may be implemented by an ASIC, XPU, or the FPGA circuitry 900 of FIG. 9 structured to perform operations corresponding to the machine readable instructions. Additionally or alternatively, the augmentation dataset generator circuitry 415 may be instantiated by any other combination of hardware, software, and/or firmware. For example, the augmentation dataset generator circuitry 415 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The output initiator circuitry 420 adds synthetic data to the original training dataset as part of improving the learning process of a machine learning model. For example, the output initiator circuitry 420 adds the synthetic data points to the augmentation dataset (e.g., D_{aug}(t)=D_{aug}(t)∪{x_{synthetic}}). In some examples, the output initiator circuitry 420 updates the dynamic training dataset

$$( e . g . , {D}^{( t )} = {D}_{train} ⋃ {D}_{aug}^{( t )} ) ,$$

allowing the fixed training data set (Dₜᵣₐᵢₙ) to be supplemented with the per-epoch, dynamic augmentation dataset

$$( {D}_{aug}^{( t )} ) .$$

The output initiator circuitry 420 incorporates synthetic data into the training process to help mitigate class imbalance and improve model performance on the minority class. As such, this allows a neural network trained with the adjusted datasets to show improvements in detections associated with deepfake image and/or video generation, as part of overall improvements in model performance and reduction of class imbalance (e.g., performance of a classification task using a predictive model based on the augmentation dataset).

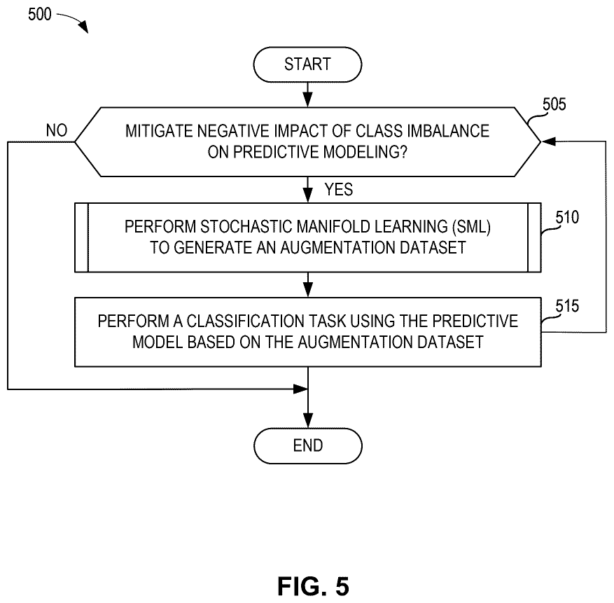

In some examples, the apparatus includes means for performing a classification task. For example, the means for performing a classification task may be implemented by output initiator circuitry 420. In some examples, the output initiator circuitry 420 may be instantiated by programmable circuitry such as the example programmable circuitry 712 of FIG. 7. For instance, the output initiator circuitry 420 may be instantiated by the example microprocessor 800 of FIG. 8 executing machine executable instructions such as those implemented by at least block 515 of FIG. 5. In some examples, the output initiator circuitry 420 may be instantiated by hardware logic circuitry, which may be implemented by an ASIC, XPU, or the FPGA circuitry 900 of FIG. 9 structured to perform operations corresponding to the machine readable instructions. Additionally or alternatively, the output initiator circuitry 420 may be instantiated by any other combination of hardware, software, and/or firmware. For example, the output initiator circuitry 420 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 425 can be used to store any information associated with the anchor point identifier circuitry 405, the k-NN neighborhood generator circuitry 410, the augmentation dataset generator circuitry 415, and/or the output initiator circuitry 420. The data storage 425 of the illustrated example of FIG. 4 can be implemented by any memory, storage device and/or storage disc for storing data such as flash memory, magnetic media, optical media, etc. Furthermore, the data stored in the data storage 425 can be in any data format such as binary data, comma delimited data, tab delimited data, structured query language (SQL) structures, image data, etc.

While an example manner of implementing the predictive model executor circuitry 105 is illustrated in FIG. 4, one or more of the elements, processes and/or devices illustrated in FIG. 4 may be combined, divided, re-arranged, omitted, eliminated and/or implemented in any other way. Further, the example anchor point identifier circuitry 405, the example k-NN neighborhood generator circuitry 410, the example augmentation dataset generator circuitry 415, the example output initiator circuitry 420, and/or, more generally, the predictive model executor circuitry 105 of FIG. 4 may be implemented by hardware, software, firmware and/or any combination of hardware, software and/or firmware. Thus, for example, any of the example anchor point identifier circuitry 405, the example k-NN neighborhood generator circuitry 410, the example augmentation dataset generator circuitry 415, the example output initiator circuitry 420, and/or, more generally, the predictive model executor circuitry 105 of FIG. 4 be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), vision processing units (VPUs), and/or field programmable logic device(s) (FPLD(s)) such as FPGAs in combination with machine readable instructions (e.g., firmware or software). Further still, the predictive model executor circuitry 105 of FIG. 4 may include one or more elements, processes, and/or devices in addition to, or instead of, those illustrated in FIG. 4, and/or may include more than one of any or all of the illustrated elements, processes and devices.

Flowcharts representative of example machine readable instructions, which may be executed by programmable circuitry to implement and/or instantiate the predictive model executor circuitry 105 of FIG. 4 and/or representative of example operations which may be performed by programmable circuitry to implement and/or instantiate the predictive model executor circuitry 105 of FIG. 4, are shown in FIGS. 5-6. The machine readable instructions may be one or more executable programs or portion(s) of one or more executable programs for execution by programmable circuitry, such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 5-6, many other methods of implementing the example predictive model executor circuitry 105 of FIG. 4 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by example programmable circuitry to implement the example predictive model executor circuitry 105 of FIG. 4. The machine-readable instructions and/or the operations 500 of FIG. 9 begin at block 505, at which the anchor point identifier circuitry 405 determines whether to mitigate a negative impact of class imbalance on predictive modeling. For example, deep learning-based predictive models (e.g., using Convolutional Neural Networks (CNNs), Recurrent Neural Networks (RNNs), etc.) are widely used for deepfake detection (e.g., analyzing video frames for subtle inconsistencies and/or artifacts indicating manipulation). CNNs can extract visual features from individual frames and/or video sequences (e.g., textures, facial artifacts, etc.), while RNNs can capture temporal dependencies between frames to detect inconsistencies in movements and/or transitions. Features extracted by the predictive model can then be fed into a classifier to determine whether the provided video is genuine or has undergone manipulation. In examples disclosed herein, the anchor point identifier circuitry 405 initiates stochastic manifold learning (SML) to generate an augmentation dataset when a predictive model indicates presence of a class imbalance, at block 505.

In some examples, the predictive model executor circuitry 105 recognizes class imbalance(s) in a predictive model when a distribution of classes (e.g., majority class data, minority class data) in the training data is skewed (e.g., such that the majority class has more instances compared to the minority class), resulting in reduced model accuracy and performance. For example, a model trained to detect deepfake videos may be very accurate in identifying genuine videos but underperform with identifications related to videos that include manipulations. Such a model can achieve high accuracy by predicting the majority class (e.g., genuine videos) but failing to achieve accurate predictions associated with the minority class (e.g., manipulated videos). Once the predictive model executor circuitry 105 generates augmentation datasets using SML, the output initiator circuitry 420 can use the training datasets to perform a classification task using the predictive model based on the generated augmentation dataset, at block 515.

FIG. 6 is a flowchart representative of example machine-readable instructions and/or example operations 510 that may be executed, instantiated, and/or performed by example programmable circuitry to implement the example predictive model executor circuitry 105 of FIG. 4 to perform stochastic manifold learning to generate an augmentation dataset. The machine-readable instructions and/or the operations 510 of FIG. 5 begin at block 605, at which the anchor point identifier circuitry 405 accesses a training dataset including (1) a fixed training dataset (Dₜᵣₐᵢₙ) and (2) an empty dynamic augmentation dataset

$$( {D}_{aug}^{( t )} ) .$$

Over time, the dynamic augmentation dataset is populated with the augmentation data (e.g., including synthetic datapoints, as described in connection with FIG. 1). The anchor point identifier circuitry 405 proceeds to initiate a for loop to populate the empty data augmentation dataset

$$( {D}_{aug}^{( t )} ) ,$$

at block 610. In the example of FIG. 6, the anchor point identifier circuitry 405 determines a classifier-based predictive error (PE) associated with a datum x, at block 615. For example, the anchor point identifier circuitry 405 accepts data points with high predictive errors as anchors for augmentation. The anchor point identifier circuitry 405 uses the predictive error to accept or reject the datum x as an anchor point (e.g., based on a set threshold), at block 620. When x is rejected as an anchor point, the anchor point identifier circuitry 405 proceeds to sample another data point and control returns to block 615.

Once the anchor point identifier circuitry 405 accepts a datum x as an anchor point based on the set threshold (e.g., such that ΔPE(x)>r, where r˜U[0,1]), at block 625, the augmentation dataset generator circuitry 415 can determine the number of synthetic data points (x*) to generate for the anchor x based on a number of data augmentations (e.g., DA(x)), at block 630. As described in connection with FIG. 1, the number of synthetic data points generated is proportional to the predictive error, controlled by parameters γ and τ. Subsequently, the k-NN neighborhood generator circuitry 410 generates a k-NN neighborhood for the anchor point x, at block 635, which includes data points (e.g., data points 121, 122, 123, 123 of FIG. 1) that share similar features with the anchor datum x (e.g., anchor datum 120 of FIG. 1). The augmentation dataset generator circuitry 415 proceeds to sample a candidate anchor-twin (x′) from the k-NN neighborhood, at block 640. When the candidate anchor-twin (x′) is accepted based on an acceptance probability threshold (e.g., e^{-ΔPE(x′)·τ}), at block 645, the augmentation dataset generator circuitry 415 generates an augmentation datum (x*) using a linear interpolation between the anchor point (x) and the anchor-twin point (x′), at block 650. For example, as described in connection with FIG. 1, the linear interpolation is represented using the anchor point and the anchor-twin point as x*=αx+(1−α)x′, where the interpolation weight is sampled as α˜U[0,1]. The adds synthetic data to the original training dataset as part of improving the learning process of the machine learning model, such that the dynamic augmentation dataset

$$( {D}_{aug}^{( t )} )$$

receives the augmentation data (e.g., synthetic data points), at block 655. The output initiator circuitry 420 incorporates synthetic data into the training process to help mitigate class imbalance and improve model performance on the minority class. The output initiator circuitry 420 further determines whether the desired number of synthetic datapoints have been generated based on the number of data augmentations determined by the augmentation dataset generator circuitry 415, at block 660. Control returns to the k-NN neighborhood generator circuitry 410 to generate a new k-NN neighborhood for the datum x, at block 635, until the identified number of data augmentations associated with x are generated.

FIG. 7 is a block diagram of an example programmable circuitry platform 700 structured to execute and/or instantiate the example machine-readable instructions and/or the example operations of FIGS. 5-6 to implement the example predictive model executor circuitry 105 of FIG. 4. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs microprocessors, CPUs, GPUs, DSPs, and/or microcontrollers from any desired family or manufacturer. The programmable circuitry 712 may be implemented by one or more semiconductor based (e.g., silicon based) devices. In this example, the processor circuitry 712 implements the anchor point identifier circuitry 405, the k-NN neighborhood generator circuitry 410, the augmentation dataset generator circuitry 415, and the.

The programmable circuitry 712 of the illustrated example includes a local memory 713 (e.g., a cache, registers, etc.). The programmable circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 700 of the illustrated example also includes one or more mass storage devices 728 to store software and/or data. Examples of such mass storage devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 732, which may be implemented by the machine readable instructions of FIGS. 5-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowcharts of FIGS. 5-6 to effectively instantiate the circuitry of FIG. 4 logic circuits to perform the operations corresponding to those machine readable instructions. In some such examples, the circuitry of FIG. 4 is instantiated by the hardware circuits of the microprocessor 800 in combination with the instructions. For example, the microprocessor 800 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5-6.

The cores 802 may communicate by a first example bus 804. In some examples, the first bus 804 may implement a communication bus to effectuate communication associated with one(s) of the cores 802. For example, the first bus 804 may implement at least one of an Inter-Integrated Circuit (I2C) bus, a Serial Peripheral Interface (SPI) bus, a PCI bus, or a PCIe bus. Additionally or alternatively, the first bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2_cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1 cache 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer-based operations. In other examples, the AL circuitry 816 also performs floating-point operations. In yet other examples, the AL circuitry 816 may include first AL circuitry that performs integer-based operations and second AL circuitry that performs floating point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 5-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 5-6. In particular, the FPGA 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 5-6. As such, the FPGA circuitry 900 may be configured and/or structured to effectively instantiate some or all of the operations/functions corresponding to the machine readable instructions of the flowcharts of FIGS. 5-6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 9. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 902 of FIG. 9 may execute a first portion of the machine readable instructions represented by the flowchart(s) of FIGS. 5-6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5-6, and/or an ASIC may be configured and/or structured to perform third operation(s)/function(s) corresponding to a third portion of the machine readable instructions represented by the flowcharts of FIGS. 5-6.

It should be understood that some or all of the circuitry of FIG. 4, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 4 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7 which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

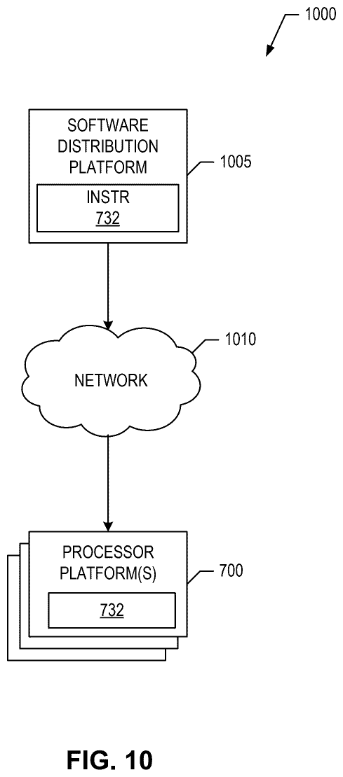

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 5-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 5-6, may be downloaded to the example programmable circuitry platform 700, which is to execute the machine readable instructions 732 to implement the predictive model executor circuitry 105 of FIG. 4. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein introduce a novel data augmentation technique (e.g., stochastic manifold learning (SML)) to mitigate the negative impact of class imbalance on predictive modeling. In examples disclosed herein, manifold learning is optimized for classification tasks by generating an augmentation dataset (e.g., per epoch) consisting of linear interpolations of minority class data points. Methods and apparatus disclosed herein generate regions that correspond with incorrect and/or low confidence minority class data predictions in the classifier latent space to merge with high confidence regions. In examples disclosed herein, SML is generalizable to any predictive model training algorithm containing imbalanced data (e.g., model-and learning algorithm-agnostic) to obtain improved overall classifier performance. For example, SNL can be implemented as part of any learning algorithm paradigm, requiring no additional models, fine-tuning and/or cross-model calibrations. In examples disclosed herein, SML ameliorates misaligned embedding instances by leveraging a dynamic training-data augmentation coupled process that uses error-based acceptance sampling. Furthermore, examples disclosed herein demonstrate the effectiveness of SML on real-world, imbalanced data when implemented for improving the accuracy of neural networks (e.g., identification of manipulated videos or images created using deep learning techniques). Thus, examples disclosed herein result in improvements to the operation of a machine.

Example methods, apparatus, systems, and articles of manufacture for stochastic manifold learning for class imbalance mitigation are disclosed herein. Further examples and combinations thereof include the following:

Example 1 includes an apparatus, comprising interface circuitry, machine-readable instructions, and at least one processor circuit to be programmed by the machine-readable instructions to evaluate an anchor data point for an augmentation dataset, the augmentation dataset included in a training dataset of a machine learning model, populate the augmentation dataset based on a linear interpolation between the anchor data point and an anchor twin data point, and perform a classification task using the machine learning model based on the augmentation dataset.

Example 2 includes the apparatus as defined in example 1, wherein one or more of the at least one processor circuit is to identify the anchor data point based on a predictive error generated by a classifier.

Example 3 includes the apparatus as defined in one or more of examples 1-2, wherein the linear interpolation represents a synthetic data point, one or more synthetic data points generated proportional to the predictive error.

Example 4 includes the apparatus as defined in one or more of examples 1-3, wherein the predictive error is identified based on a ground-truth label for the anchor data point and a parameter associated with an acceptance probability threshold.

Example 5 includes the apparatus as defined in one or more of examples 1-4, wherein one or more of the at least one processor circuit is to train the machine learning model using the one or more synthetic data points.

Example 6 includes the apparatus as defined in one or more of examples 1-5, wherein one or more of the at least one processor circuit is to generate a k-Nearest Neighbors (k-NN) neighborhood for the anchor data point.

Example 7 includes the apparatus as defined in one or more of examples 1-6, wherein one or more of the at least one processor circuit is to sample a candidate anchor twin data point from the k-NN neighborhood.

Example 8 includes the apparatus as defined in one or more of examples 1-7, wherein one or more of the at least one processor circuit is to accept the candidate anchor twin data point as the anchor twin data point based on an acceptance probability threshold.

Example 9 includes the apparatus as defined in one or more of examples 1-8, wherein one or more of the at least one processor circuit is to define the k-NN neighborhood with respect to latent model embeddings.

Example 10 includes at least one non-transitory machine-readable medium comprising machine-readable instructions to cause at least one processor circuit to at least evaluate an anchor data point for an augmentation dataset, the augmentation dataset included in a training dataset of a machine learning model, populate the augmentation dataset based on a linear interpolation between the anchor data point and an anchor twin data point, and perform a classification task using the machine learning model based on the augmentation dataset.

Example 11 includes the at least one non-transitory machine-readable medium as defined in example 10, wherein the machine-readable instructions are to cause one or more of the at least one processor circuit to identify the anchor data point based on a predictive error generated by a classifier.

Example 12 includes the at least one non-transitory machine-readable medium as defined in one or more of examples 10-11, wherein the linear interpolation represents a synthetic data point, one or more synthetic data points generated proportional to the predictive error.

Example 13 includes the at least one non-transitory machine-readable medium as defined in one or more of examples 10-12, wherein the predictive error is identified based on a ground-truth label for the anchor data point and a parameter associated with an acceptance probability threshold.

Example 14 includes the at least one non-transitory machine-readable medium as defined in one or more of examples 10-13, wherein the machine-readable instructions are to cause one or more of the at least one processor circuit to train the machine learning model using the one or more synthetic data points.

Example 15 includes the at least one non-transitory machine-readable as defined in one or more of examples 10-14, wherein the machine-readable instructions are to cause one or more of the at least one processor circuit to generate a k-Nearest Neighbors (k-NN) neighborhood for the anchor data point.

Example 16 includes the at least one non-transitory machine-readable medium as defined in one or more of examples 10-15, wherein the machine-readable instructions are to cause one or more of the at least one processor circuit to sample a candidate anchor twin data point from the k-NN neighborhood.

Example 17 includes the at least one non-transitory machine-readable medium as defined in one or more of examples 10-16, wherein the machine-readable instructions are to cause one or more of the at least one processor circuit to define the k-NN neighborhood with respect to latent model embeddings.

Example 18 includes an apparatus, comprising means for evaluating an anchor data point for an augmentation dataset, the augmentation dataset included in a training dataset of a machine learning model, means for populating the augmentation dataset based on a linear interpolation between the anchor data point and an anchor twin data point, and means for performing a classification task using the machine learning model based on the augmentation dataset.

Example 19 includes the apparatus as defined in example 18, wherein the means for evaluating is to identify the anchor data point based on a predictive error generated by a classifier.

Example 20 includes the apparatus as defined in one or more of examples 18-19, wherein the linear interpolation represents a synthetic data point, one or more synthetic data points generated proportional to the predictive error.

Example 21 includes the apparatus as defined in one or more of examples 18-20, wherein the predictive error is identified based on a ground-truth label for the anchor data point and a parameter associated with an acceptance probability threshold.

Example 22 includes the apparatus as defined in one or more of examples 18-21, wherein the means for performing a classification task include training the machine learning model using the one or more synthetic data points.

Example 23 includes the apparatus as defined in one or more of examples 18-22, further including means for generating to generate a k-Nearest Neighbors (k-NN) neighborhood for the anchor data point.

Example 24 includes the apparatus as defined in one or more of examples 18-23, wherein the means for populating the augmentation dataset include sampling a candidate anchor twin data point from the k-NN neighborhood.

Example 25 includes the apparatus as defined in one or more of examples 18-24, further including means for generating to generate a k-Nearest Neighbors (k-NN) neighborhood to define the k-NN neighborhood with respect to latent model embeddings.

Example 26 includes a method including evaluating an anchor data point for an augmentation dataset, the augmentation dataset included in a training dataset of a machine learning model, populating the augmentation dataset based on a linear interpolation between the anchor data point and an anchor twin data point, and performing a classification task using the machine learning model based on the augmentation dataset.

Example 27 includes the method as defined in example 26, wherein one or more of the at least one processor circuit is to identify the anchor data point based on a predictive error generated by a classifier.

Example 28 includes the method as defined in one or more of examples 26-27, wherein the linear interpolation represents a synthetic data point, one or more synthetic data points generated proportional to the predictive error.

Example 29 includes the method as defined in one or more of examples 26-28, wherein the predictive error is identified based on a ground-truth label for the anchor data point and a parameter associated with an acceptance probability threshold.

Example 30 includes the method as defined in one or more of examples 26-29, further including training the machine learning model using the one or more synthetic data points.

Example 31 includes the method as defined in one or more of examples 26-30, further including generating a k-Nearest Neighbors (k-NN) neighborhood for the anchor data point.

Example 32 includes the method as defined in one or more of examples 26-31, further including sampling a candidate anchor twin data point from the k-NN neighborhood.

Example 33 includes the method as defined in one or more of examples 26-32, further including accepting the candidate anchor twin data point as the anchor twin data point based on an acceptance probability threshold.

Example 34 includes the method as defined in one or more of examples 26-33, further including defining the k-NN neighborhood with respect to latent model embeddings.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
evaluate an anchor data point for an augmentation dataset, the augmentation dataset included in a training dataset of a machine learning model;
populate the augmentation dataset based on a linear interpolation between the anchor data point and an anchor twin data point; and
perform a classification task using the machine learning model based on the augmentation dataset.

2. The apparatus of claim 1, wherein one or more of the at least one processor circuit is to identify the anchor data point based on a predictive error generated by a classifier.

3. The apparatus of claim 2, wherein the linear interpolation represents a synthetic data point, one or more synthetic data points generated proportional to the predictive error.

4. The apparatus of claim 3, wherein the predictive error is identified based on a ground-truth label for the anchor data point and a parameter associated with an acceptance probability threshold.

5. The apparatus of claim 3, wherein one or more of the at least one processor circuit is to train the machine learning model using the one or more synthetic data points.

6. The apparatus of claim 1, wherein one or more of the at least one processor circuit is to generate a k-Nearest Neighbors (k-NN) neighborhood for the anchor data point.

7. The apparatus of claim 6, wherein one or more of the at least one processor circuit is to sample a candidate anchor twin data point from the k-NN neighborhood.

8. The apparatus of claim 7, wherein one or more of the at least one processor circuit is to accept the candidate anchor twin data point as the anchor twin data point based on an acceptance probability threshold.

9. The apparatus of claim 6, wherein one or more of the at least one processor circuit is to define the k-NN neighborhood with respect to latent model embeddings.

10. At least one non-transitory machine-readable medium comprising machine-readable instructions to cause at least one processor circuit to at least:
evaluate an anchor data point for an augmentation dataset, the augmentation dataset included in a training dataset of a machine learning model;
populate the augmentation dataset based on a linear interpolation between the anchor data point and an anchor twin data point; and
perform a classification task using the machine learning model based on the augmentation dataset.

11. The at least one non-transitory machine-readable medium of claim 10, wherein the machine-readable instructions are to cause one or more of the at least one processor circuit to identify the anchor data point based on a predictive error generated by a classifier.

12. The at least one non-transitory machine-readable medium of claim 11, wherein the linear interpolation represents a synthetic data point, one or more synthetic data points generated proportional to the predictive error.

13. The at least one non-transitory machine-readable medium of claim 12, wherein the predictive error is identified based on a ground-truth label for the anchor data point and a parameter associated with an acceptance probability threshold.

14. The at least one non-transitory machine-readable medium of claim 12, wherein the machine-readable instructions are to cause one or more of the at least one processor circuit to train the machine learning model using the one or more synthetic data points.

15. The at least one non-transitory machine-readable medium of claim 10, wherein the machine-readable instructions are to cause one or more of the at least one processor circuit to generate a k-Nearest Neighbors (k-NN) neighborhood for the anchor data point.

16. The at least one non-transitory machine-readable medium of claim 15, wherein the machine-readable instructions are to cause one or more of the at least one processor circuit to sample a candidate anchor twin data point from the k-NN neighborhood.

17. The at least one non-transitory machine-readable medium of claim 15, wherein the machine-readable instructions are to cause one or more of the at least one processor circuit to define the k-NN neighborhood with respect to latent model embeddings.

18. An apparatus, comprising:
means for evaluating an anchor data point for an augmentation dataset, the augmentation dataset included in a training dataset of a machine learning model;
means for populating the augmentation dataset based on a linear interpolation between the anchor data point and an anchor twin data point; and
means for performing a classification task using the machine learning model based on the augmentation dataset.

19. The apparatus of claim 18, wherein the means for evaluating is to identify the anchor data point based on a predictive error generated by a classifier.

20. The apparatus of claim 18, further including means for generating to generate a k-Nearest Neighbors (k-NN) neighborhood for the anchor data point.
